(19) United States
(12) Patent Application Publication
(10) Pub. No.: US 2010/0118960 A1
(43) Pub. Date: May 13, 2010

(54) IMAGE DECODING APPARATUS, IMAGE DECODING METHOD, AND IMAGE DATA CONVERTING APPARATUS

(75) Inventor: Nobuhiro Nonogaki, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/493,659

(22) Filed: Jun. 29, 2009

(30) Foreign Application Priority Data
Nov. 13, 2008 (JP) 2008-291220

(51) Int. Cl. H04N 7/26; G06K 9/36

(52) U.S. Cl. 375/240.16; 382/232; 375/E07.123

(57) ABSTRACT

An image decoding apparatus includes a syntax-element compressing unit that executes compression processing on syntax elements extracted in syntax analysis processing and classifies the syntax elements based on types thereof, a plurality of syntax-element expanding units that correspond to any one of classified groups of syntax elements in a one to one relation and expand the syntax elements belonging to the corresponding group to restore the original syntax elements, and a plurality of signal processing units that correspond to any one of the syntax-element expanding units in a one to one relation and apply, to the syntax elements restored by the corresponding syntax-element expanding unit, signal processing corresponding to a type thereof.

### CROSS-REFERENCE TO RELATED APPLICATIONS

This application is based upon and claims the benefit of priority from the prior Japanese Patent Application No. 2008-291220, filed on Nov. 13, 2008; the entire contents of which are incorporated herein by reference.

### BACKGROUND OF THE INVENTION

1. Field of the Invention

The present invention relates to an image decoding apparatus that includes a plurality of processors and a shared cache memory and applies various kinds of signal processing to an input image signal in parallel, an image decoding method, and an image data converting apparatus.

2. Description of the Related Art

As a method in the past for applying signal processing to an input image signal in parallel, for example, there is a technology disclosed in Japanese Patent Application Laid-Open No. 2007-318517. In a method of processing image data disclosed in Japanese Patent Application Laid-Open No. 2007-318517, slices are cyclically allocated to a plurality of arithmetic processing units in order to cause the arithmetic processing units to simultaneously process the slices in parallel. Parallel processing is set to simultaneously access a memory by making use of a characteristic that macro blocks referred to in the processing of the slices overlap. Consequently, a load on a bus caused when the arithmetic processing units access the memory is reduced. Therefore, usage of the memory is also reduced.

Japanese Patent Application Laid-Open No. 2008-118616 discloses a technology for using a plurality of threads, allocating an input bit stream (an image signal) to the threads for each of pictures, and collectively carrying out syntax analysis and decoding for each of the pictures in parallel.

However, the technologies in the past have problems that should be solved. Specifically, in the technology disclosed in Japanese Patent Application Laid-Open No. 2007-318517, when most of targets of arithmetic processing are data that do not overlap among slices as in a syntax analysis result of a bit stream, a sufficient effect cannot be obtained. Therefore, the technology cannot be effectively used. In the technology disclosed in Japanese Patent Application Laid-Open No. 2008-118616, syntax analysis and signal processing for slices are collectively performed in the same thread. Therefore, it is difficult to share reference to data overlapping among the slices. In particular, cache memory usage during writing in a picture substantially increases.

### BRIEF SUMMARY OF THE INVENTION

An image decoding apparatus according to an embodiment of the present invention comprises: a syntax-element compressing unit that executes compression processing on syntax elements extracted in syntax analysis processing on a bit stream and classifies obtained syntax elements after the compression based on types thereof; a plurality of syntax-element expanding units that correspond to any one of classified groups of syntax elements in a one to one relation and expand the syntax elements belonging to the corresponding group to restore the original syntax elements; and a plurality of signal processing units that correspond to any one of the syntax-element expanding units in a one to one relation and apply, to the syntax elements restored by the corresponding syntax-element expanding unit, signal processing corresponding to a type thereof.

An image decoding method according to an embodiment of the present invention comprises: applying compression processing to syntax elements obtained in syntax analysis processing for a bit stream, classifying the syntax elements after the compression based on types thereof, and storing the syntax elements in the inter-core shared cache memory; and allocating a different processor to each of the classified groups of syntax elements and executing respective kinds of signal processing corresponding to the respective groups of syntax elements.

An image data converting apparatus according to an embodiment of the present invention comprises: a syntax analyzing unit that executes syntax analysis processing on an input image bit stream; and a syntax-element compressing unit that converts a specific parameter included in syntax elements extracted in the syntax analysis processing by the syntax analyzing unit into a variable length code including a 3-bit type bit, a value of the type bit itself indicating an absolute value of the parameter before the compression when the value of the type bit is 0 to 5, a value obtained by adding 6 to a next value of 1 byte indicating an absolute value of the parameter before the compression when the value of the type bit is 6, and a value obtained by adding 262 to a next value of 2 bytes indicating an absolute value of the parameter before the compression when the value of the type bit is 7.

### BRIEF DESCRIPTION OF THE DRAWINGS

FIG. 1 is a diagram of a basic configuration of an image decoding apparatus according to a first embodiment of the present invention;

FIG. 2 is a diagram of an example of architecture for realizing the image decoding apparatus;

FIG. 3 is a diagram of a configuration example of an image decoding apparatus adopted when an input bit stream is H.264/MPEG-4 AVC;

FIG. 4 is a diagram of the structure of parameters after compression;

FIG. 5 is a diagram of a compression result obtained by motion prediction information is compressed;

FIG. 6 is a diagram of a compression result obtained when information of a differential image is compressed;

FIG. 7 is a diagram of a configuration example of an image decoding apparatus according to a second embodiment of the present invention; and

FIG. 8 is a diagram of a relation among kinds of processing executed in the image decoding apparatus according to the second embodiment.

### DETAILED DESCRIPTION OF THE INVENTION

Exemplary embodiments of an image decoding apparatus, an image decoding method, and an image data converting apparatus according to the present invention will be explained below in detail with reference to the accompanying drawings. The present invention is not limited to the following embodiments.

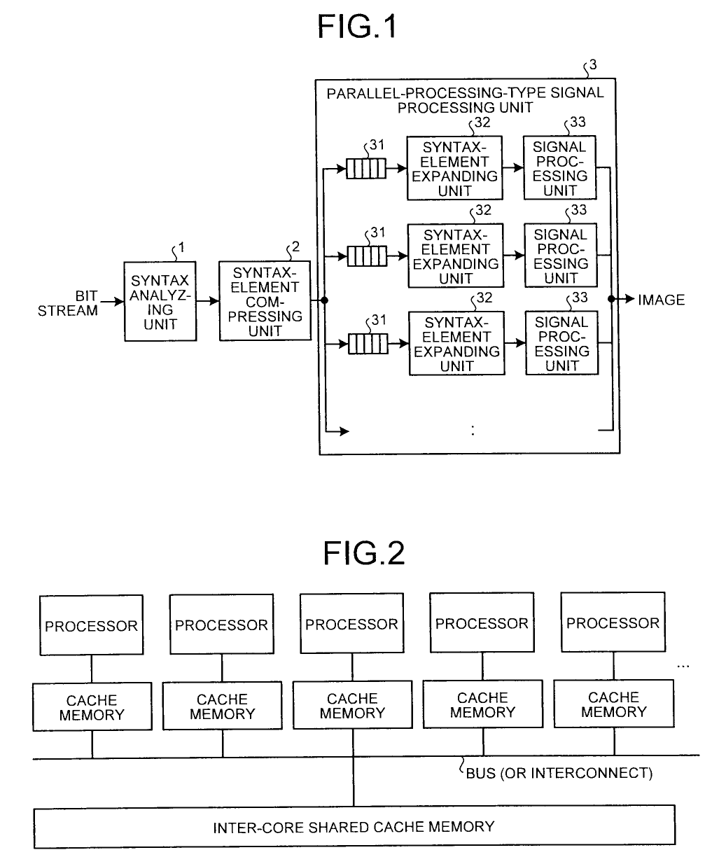

FIG. 1 is a diagram of a basic configuration of an image decoding apparatus according to a first embodiment of the present invention. The image decoding apparatus includes a syntax analyzing unit 1, a syntax-element compressing unit 2, and a parallel-processing-type signal processing unit 3. The syntax analyzing unit 1 applies syntax analysis to a bit stream of an input image signal and extracts syntax elements. The syntax-element compressing unit 2 compresses (converts) the extracted syntax elements in systems specified in advance for respective kinds of the syntax elements. The parallel-processing-type signal processing unit 3 includes a plurality of queues 31 that classify the syntax elements after compression based on the types thereof and stores the same, a plurality of syntax-element expanding unit 32 that expands the syntax elements after the compression stored in the queues into the original syntax elements, and a plurality of signal processing units 33 that applies corresponding signal processing to the expanded syntax elements. The parallel-processing-type signal processing unit 3 executes the signal processing for the syntax elements in parallel for the respective kinds of the syntax elements and restores an original image (a transmitted image) based on results of the kinds of processing executed in parallel. In FIG. 1, a component that restores the image based on the processing results is not shown.

Such an image decoding apparatus is realized by, for example, executing software for image decoding on an apparatus including a plurality of pairs of processors and cache memories exclusively used by the processors and an inter-core shared cache memory usable by the processors shown in FIG. 2. FIG. 2 is a diagram of an example of architecture for realizing the image decoding apparatus. A method of realizing the image decoding apparatus is not limited to this.

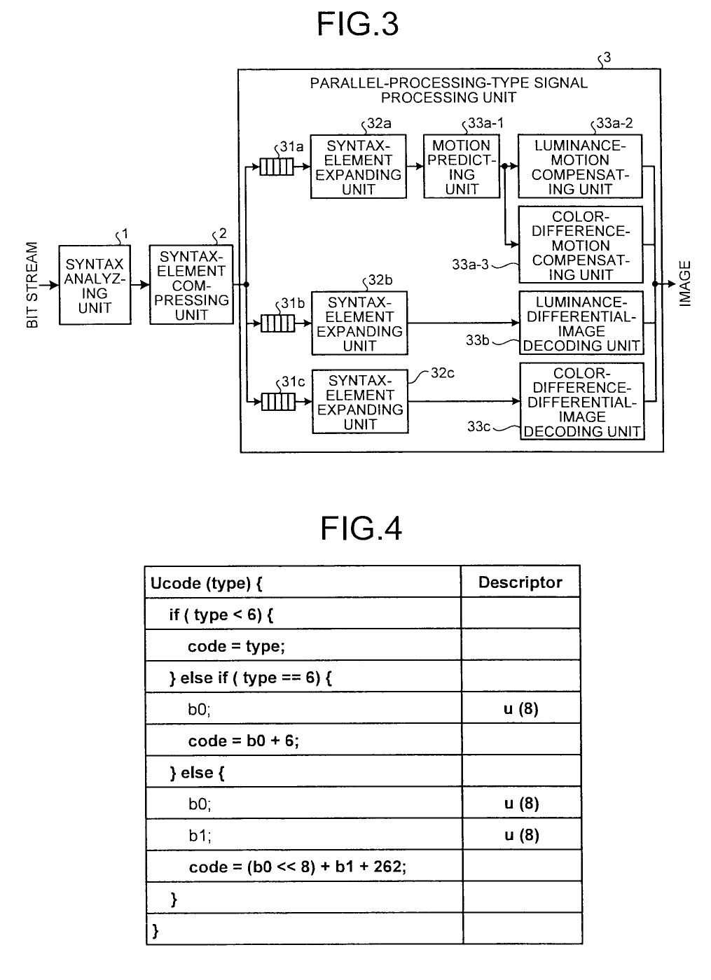

FIG. 3 is a diagram of a configuration example of an image decoding apparatus adopted when an input bit stream to be processed is H.264/MPEG-4 AVC. In FIG. 3, a configuration of the parallel-processing-type signal processing unit 3 of the image decoding apparatus shown in FIG. 1 is more specifically shown. The parallel-processing-type signal processing unit 3 includes components for executing five kinds of processing executable in parallel, i.e., motion prediction, luminance motion compensation, color difference motion compensation, luminance differential image decoding, and color difference differential image decoding. Syntax elements are directly referred to in the three kinds of processing, i.e., the motion prediction, the luminance differential image decoding, and the color difference differential image decoding. Therefore, the parallel-processing-type signal processing unit 3 of the image decoding apparatus shown in FIG. 3 includes a plurality of queues 31a, 31b, and 31c, a plurality of syntax-element expanding units 32a, 32b, and 32c, a motion predicting unit 33a-1, a luminance-motion compensating unit 33a-2, a color-difference-motion compensating unit 33a-3, a luminance-difference-image decoding unit 33b, and a color-difference-differential-image decoding unit 33c.

The syntax elements compressed by the syntax-element compressing unit 2 are classified based on types thereof and stored in the queues 31a, 31b, and 31c.

The syntax-element expanding units 32a, 32b, and 32c extract the compressed syntax elements from the queues at the pre-stage and expands the syntax elements in procedures corresponding to the types thereof to restore the original syntax elements (before the compression).

The motion predicting unit 33a-1 performs motion prediction based on the syntax elements restored by the syntax-element expanding unit 32a. The luminance-motion compensating unit 33a-2 and the color-difference-motion compensating unit 33a-3 respectively perform motion compensation for luminance and motion compensation for color difference based on a result of the motion prediction by the motion predicting unit 33a-1.

The luminance-difference-image decoding unit 33b decodes differential image data concerning luminance based on the syntax elements restored by the syntax-element expanding unit 32b. The color-difference-differential-image decoding unit 33c decodes differential image data concerning color difference based on the syntax elements restored by the syntax-element expanding unit 32c.

A detailed operation of the image decoding apparatus having the configuration shown in FIG. 3 is explained. Operations of the syntax-element compressing unit 2 and the syntax-element expanding units 32a, 32b, and 32c, which are components for realizing characteristic operations in the image decoding apparatus, are mainly explained.

The syntax-element compressing unit 2 receives a syntax analysis result (syntax elements extracted from an input bit stream) from the syntax analyzing unit 1 and converts the syntax elements into variable length codes of a format explained later to thereby compress the syntax elements. The syntax-element compressing unit 2 classifies the syntax elements after the compression according to types thereof and stores the syntax elements in queues corresponding thereto. Specifically, the syntax-element compressing unit 2 classifies the syntax elements into syntax elements (syntax elements after the compression) concerning motion prediction, syntax elements concerning luminance differential image decoding, and syntax elements concerning color difference differential image decoding and stores the syntax elements in the queues corresponding thereto. For example, the syntax-element compressing unit 2 compresses the syntax elements concerning motion prediction and then stores the syntax elements in the queue 31a.

Details of a format of the syntax elements after the compression output from the syntax-element compressing unit 2 are explained. The syntax elements include one or more parameters. The syntax-element compressing unit 2 converts specific parameters into variable length codes among the parameters included in the syntax elements and compresses the parameters to thereby compress the syntax elements. FIG. 4 is a diagram of the structure of the parameters (the variable length codes) after the compression obtained by converting the specific parameters in the syntax elements into the variable length codes. In the variable length codes shown in FIG. 4, type takes a value from 0 to 7 and is represented by 3 bits. In the variable length codes shown in FIG. 4, when type is 0 to 5, a value of type itself is an original parameter value (before the compression) (equivalent to a value of “code” in FIG. 4). When type is 6, a value obtained by adding 6 to the next value of 1 byte (equivalent to a value of “b0”) is the original parameter value. When type is 7, a value obtained by adding 262 to a value, which is the next value of 2 bytes (equivalent to values of “b0” and “b1”) regarded as one binary integer, is the original parameter value. With this compression method, compression without loss can be performed when, concerning an absolute value of a value, (a) a frequency that the value is smaller than 7 and (b) a frequency that the value is larger than 262 are compared and a relation “(a)>(b)” holds. Therefore, the compression method is suitable for compressing syntax elements of a moving image having parameter values, appearance frequencies of most of which are numerical values close to 0.

As compression performance for the variable length codes, Context-Adaptive Variable Length Coding (CAVLC) and Context-Adaptive Binary Arithmetic Coding (CABAC) specified in the H.264/MPEG-4 AVC standard or the like indicate overwhelmingly better performance. However, for decoding of these code words, context information around the code words is necessary, which prevents parallel signal processing. On the other hand, the variable length codes of the format shown in FIG. 4 has high locality and is suitable for parallel processing because the variable length codes can be decoded by only type.

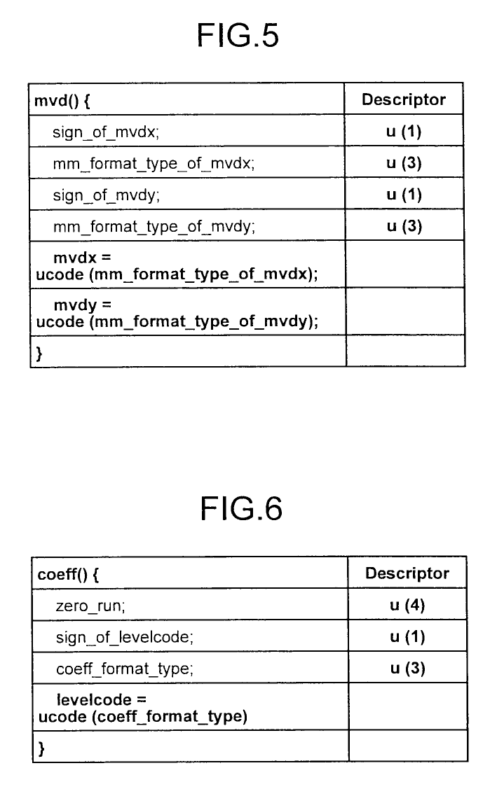

FIG. 5 is a diagram of a compression result (the structure of the syntax elements after the compression) obtained when the syntax-element compressing unit 2 compresses the syntax elements concerning motion prediction (motion prediction information) using the variable length codes having the structure shown in FIG. 4. In the figure, notation “u(n)” in “Descriptor” means that n bits on the variable length codes obtained by compressing are read out as an integer without code (the integer without code is represented by specific n bits).

The motion prediction information is a set (mvdx, mvdy) of differential values (parameters) of calculation results of motion prediction algorithms in the horizontal direction and the vertical direction and present values. Therefore, mvdx and mvdy are divided into signs (∓) and absolute values, the signs are represented by 1 bit (sign_of_mvdx, sign_of_mvdy), and the absolute values are represented by 3 bits (mm_format_type_of_mvdx, mm_format_type_of_mvdy) equivalent to type explained in the compression procedure (see FIG. 4). Therefore, as shown in FIG. 5, the syntax elements after the compression (the set of mvdx and mvdy after the compression) are a sequence of the sign of mvdx (1 bit) and 3-bit information equivalent to type (type shown in FIG. 4), the sign of mvdy (1 bit) and 3-bit information equivalent to type, and ucodes of mvdx and mvdy (two kinds of variable length information following mm_format_type_of_mvdy). When the pieces of code information of mvdx and mvdy (1 bit each) and the pieces of information (3 bits each) equivalent to type are totaled, a totaled value can be represented by just 8 bits=1 byte, which is a unit (length) suitable for processing of software.

FIG. 6 is a diagram of a compression result (the structure of the syntax elements after the compression) obtained when the syntax-element compressing unit 2 compresses the syntax elements (the information of the differential image) concerning the differential image decoding (the luminance differential image decoding and the color difference differential image decoding) using the variable length codes having the structure shown in FIG. 4. Concerning the differential image, units of parallel processing for luminance and color difference are different. Therefore, a plurality of queues corresponding thereto are provided, respectively (see FIG. 3). However, because formats (the structure of included information) of the syntax elements of both the luminance and color difference are the same, the syntax elements after the compression are the same format (can be compressed and expanded in the same procedure).

The information of the differential image is represented by parameters obtained by zigzag-scanning a coefficient matrix of DCT. Specifically, the information of the differential image is represented by a set of a parameter (zero_run) indicating the number of continuous 0's detected in the zigzag-scan and a parameter indicating coefficients (non-zero coefficients). When the coefficient matrix is treated as a matrix in a unit of 4×4, zero_run is 15 at the maximum. Therefore, this parameter is represented by 4 bits. On the other hand, the non-zero coefficient is divided into a sign (∓) and an absolute value, the sign is represented by 1 bit (sign_of_levelcode), and the absolute value is represented by 3 bits (coeff format type) equivalent to type (see FIG. 4). Therefore, as shown in FIG. 6, the syntax elements after the compression are a sequence of the number of continuous 0's (4 bits), the sign of the coefficient other than 0 (1 bit) and 3-bit information equivalent to type, and ucode of the coefficient other than 0 (variable length information following coeff_format_type, when type is 6 or 7). In this case, a fixed length information section (a section other than ucode) is represented by just 8 bits=1 byte, which is a unit suitable for processing of software.

The operations of the image decoding apparatus having the configuration shown in FIG. 3 are explained again. In the parallel-processing-type signal processing unit 3, the syntax-analysis expanding unit 32a reads out the syntax elements concerning the motion prediction after the compression stored in the queue 31a, executes processing opposite to the processing executed by the syntax-element compressing unit 2 in compressing the syntax elements concerning the motion prediction, and restores the original syntax elements. The restored syntax elements are passed to the motion predicting unit 33a-1 at the post stage and predetermined signal processing is executed. After being used in the motion predicting unit 33a-1, the restored syntax elements are immediately discarded when processing by the luminance-motion compensating unit 33a-2 and the color-difference-motion compensating unit 33a-3 executed following the signal processing is finished.

Similarly, the syntax-element expanding unit 32b reads out the syntax elements concerning the luminance differential image decoding after the compression stored in the queue 31b, executes processing opposite to the processing executed by the syntax-element compressing unit 2, and restores the original syntax elements. The syntax-element expanding unit 32c reads out the syntax elements concerning the color difference differential image decoding after the compression stored in the queue 31c, executes processing opposite to the processing executed by the syntax-element compressing unit 2, and restores the original syntax elements. The restored syntax elements are passed to the luminance-differential-image decoding unit 33b and the color-difference-differential-image decoding unit 33c at the post stage, respectively. The syntax elements are immediately discarded after being used in predetermined signal processing.

As explained above, the image decoding apparatus according to this embodiment converts the specific parameters in the various syntax elements obtained by executing the syntax analysis into the variable length codes and compresses the parameters to thereby compress the syntax elements. The image decoding apparatus classifies the syntax elements after the compression based on types thereof and stores the syntax elements in the queues. The image decoding apparatus expands the syntax elements immediately before using the syntax elements in the parallel signal processing at the post stage (restores the syntax elements to the state before the compression). After using the syntax elements in the signal processing, the image decoding apparatus immediately discards the syntax elements. This makes it possible to perform the various kinds of signal processing for decoding an image bit stream in parallel while preventing usage of the cache memory from increasing.

In the first embodiment, the image decoding apparatus that executes the various kinds of signal processing on the single image bit stream in parallel while holding down usage of the cache memory is explained. On the other hand, in a second embodiment of the present invention, an image processing apparatus that executes various kinds of signal processing on a plurality of image bit streams in parallel while holding down usage of a cache memory is explained.

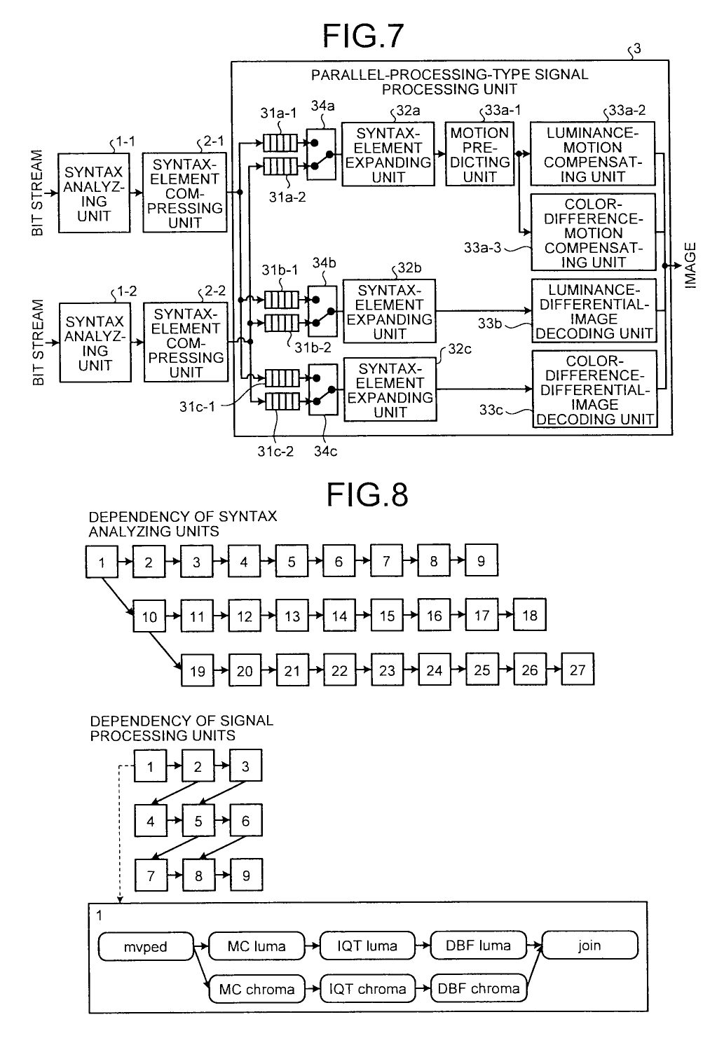

FIG. 7 is a diagram of a configuration example of the image decoding apparatus according to the second embodiment. In the configuration example, an input bit stream is H.264/MPEG-4 AVC. Components same as those of the image decoding apparatus according to the first embodiment are denoted by the same reference numerals and signs. In the image decoding apparatus according to this embodiment, the syntax analyzing unit 1, the syntax-element compressing unit 2, and the queues 31a, 31b, and 31c of the image decoding apparatus shown in FIG. 3 are replaced with syntax analyzing units 1-1 and 1-2, syntax-element compressing units 2-1 and 2-2, and queues 31a-1, 31a-2, 31b-1, 31b-2, 31c-1, and 31c-2. Switches 34a, 34b, and 34c are added between the queues and the syntax-element expanding units. The syntax analyzing units 1-1 and 1-2 execute processing same as that of the syntax analyzing unit 1 explained in the first embodiment. The syntax-element compressing units 2-1 and 2-2 execute processing same as that of the syntax-element compressing unit 2.

As shown in the figure, the syntax-element compressing units 2-n (n=1 and 2) and the queues 31a-n, 31b-n, and 31c-n are associated with each other. The syntax-element compressing units classify syntax elements after compression based on types thereof and store the syntax elements in any ones of the queues associated with the syntax-element compressing units. Each of the switches 34a, 34b, and 34c extracts the compressed syntax elements from any one of the two queues at the pre-stage. A method of compressing the syntax elements is as explained in the first embodiment. Conditions for switching the switches are not particularly specified. For example, when a queue is about to overflow, the switches are switched to extract the compressed syntax elements from the queue or, when a connected queue is emptied, the switches are switched to another queue side.

In the image decoding apparatus having such a configuration, for example, an input image signal (video signal) is assigned to any ones of the syntax analyzing units for each of slices or pictures. The syntax analyzing units and the components at the post stage execute processing same as that of the components of the image decoding apparatus explained in the first embodiment to decode an image.

In FIG. 7, the image bit streams are input in two systems. However, the systems can be expanded to three or more systems by using the same method.

FIG. 8 is a diagram of a relation among kinds of processing executed in the image decoding apparatus according to this embodiment. Squares indicate slices. Nine slices are included in one picture. Each of sets of slices 1 to 9, slices 10 to 18, and slices 19 to 27 form one picture. In FIG. 8, dependency of the slices is indicated by arrows. In an upper part of the figure, dependency of syntax analysis processing (processing of the syntax analyzing units) is shown. In a middle part of the figure, dependency of signal processing (processing by the parallel-processing-type signal processing unit) is shown. In a lower part of the figure, dependency of respective kinds of signal processing is shown. However, the dependency shown in the figure is only an example.

In the image decoding apparatus according to this embodiment, as shown in the upper part of FIG. 8, for example, a first slice of each of the pictures refers to the preceding picture. After the syntax analysis processing for a certain picture is started, when syntax analysis for the first slice is finished, the syntax analysis processing for the next picture can be performed. The syntax analysis processing for the pictures can be carried out in parallel. For simplification of explanation, processing by the syntax-element compressing unit is not explained. However, actually, compression processing for a syntax analysis result is performed following the syntax analysis processing.

As shown in the middle part of the figure, the signal processing for the slices can be executed in parallel when the processing for the slice referred to is completed. For example, when the signal processing for a second slice shown in the figure is completed, the signal processing for third and fourth slices, which refer to the second slice, can be executed in parallel. Further, as shown in the lower part of the figure, in the signal processing, respective kinds of signal processing (MC: motion compensation, IQT: inverse quantization, and DBF: deblocking filter) for luma (luminance) and chroma (chromaticity) can be executed in parallel.

As explained above, the image decoding apparatus according to this embodiment includes a plurality of systems of the syntax analyzing units and the syntax-element compressing units and further includes a plurality of queues and switches corresponding to the systems. Consequently, effects same as those of the image decoding apparatus explained in the first embodiment can be obtained. Further, the signal processing can be performed in parallel for the processing concerning syntax analysis (the syntax analysis processing and the compression processing for a syntax analysis result).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image decoding apparatus comprising:
a syntax-element compressing unit that executes compression processing on syntax elements extracted in syntax analysis processing on a bit stream and classifies obtained syntax elements after the compression based on types thereof;
a plurality of syntax-element expanding units that correspond to any one of classified groups of syntax elements in a one to one relation and expand the syntax elements belonging to the corresponding group to restore the original syntax elements; and
a plurality of signal processing units that correspond to any one of the syntax-element expanding units in a one to one relation and apply, to the syntax elements restored by the corresponding syntax-element expanding unit, signal processing corresponding to a type thereof.

2. The image decoding apparatus according to claim 1, wherein the syntax-element expanding units and the signal processing units are provided in the same number as the syntax element groups.

3. The image decoding apparatus according to claim 1, wherein
a plurality of the syntax-element compressing units are provided, and
the syntax-element compressing units allocate parameters after compression such that a same kind of the syntax elements after the compression output from the syntax-element compressing units belong to a same group.

4. The image decoding apparatus according to claim 1, further comprising a plurality of queues that store the syntax elements after the compression, wherein the syntax-element compressing unit stores the syntax elements after the compression in the queue associated with a type thereof.

5. The image decoding apparatus according to claim 1, wherein the syntax-element compressing unit classifies the syntax elements after the compression into three kinds of syntax elements, i.e., syntax elements used in motion prediction processing, syntax elements used in differential image decoding processing concerning luminance, and syntax elements used in differential image decoding processing concerning color difference.

6. The image decoding apparatus according to claim 1, wherein the syntax-element compressing unit executes, as the compression processing, processing for converting a specific parameter included in the syntax elements extracted in the syntax analysis processing into a variable length code including a 3-bit type bit, a value of the type bit itself indicating an absolute value of the parameter before the compression when the value of the type bit is 0 to 5, a value obtained by adding 6 to a next value of 1 byte indicating an absolute value of the parameter before the compression when the value of the type bit is 6, and a value obtained by adding 262 to a next value of 2 bytes indicating an absolute value of the parameter before the compression when the value of the type bit is 7.

7. The image decoding apparatus according to claim 6, wherein the syntax-element compressing unit converts, in compressing the syntax elements used in the motion prediction processing, a specific parameter included in the syntax elements into a variable length code including a 3-bit type bit and a 1-bit code bit corresponding to a motion prediction result in a vertical direction, a 3-bit type bit and a 1-bit code bit corresponding to a motion prediction result in a horizontal direction, and 4-byte or less additional information added according to values of the type bits.

8. The image decoding apparatus according to claim 6, wherein the syntax-element compressing unit converts, in compressing the syntax elements used in the differential image decoding processing, a specific parameter included in the syntax elements into a variable length code including 4-bit information indicating a number of continuous 0's detected in zigzag scan, a 3-bit type bit and a 1-bit code bit corresponding to a coefficient other than 0, and 2-byte or less additional information added according to a value of the type bit.

9. The image decoding apparatus according to claim 1, wherein, among the signal processing units, a signal processing unit that executes processing concerning motion prediction performs motion prediction processing first and then performs motion compensation concerning luminance and color difference in parallel based on a motion prediction processing result.

10. The image decoding apparatus according to claim 1, wherein the image decoding apparatus discards, after the processing in the signal processing units is finished, the syntax elements used in the processing.

11. The image decoding apparatus according to claim 1, wherein the image decoding apparatus adopts architecture including a plurality of pairs of processors and cache memories exclusively used by the processors and an inter-core shared cache memory usable by the processors.

12. An image decoding method executed in a system that adopts architecture including a plurality of pairs of processors and cache memories exclusively used by the processors and an inter-core shared cache memory usable by the processors, the image decoding method comprising:
applying compression processing to syntax elements obtained in syntax analysis processing for a bit stream, classifying the syntax elements after the compression based on types thereof, and storing the syntax elements in the inter-core shared cache memory; and
allocating a different processor to each of the classified groups of syntax elements and executing respective kinds of signal processing corresponding to the respective groups of syntax elements.

13. The image decoding method according to claim 12, wherein, in applying the compression processing to the syntax elements, the syntax elements after the compression are classified into three kinds of syntax elements, i.e., syntax elements used in motion prediction processing, syntax elements used in differential image decoding processing concerning luminance, and syntax elements used in differential image decoding processing concerning color difference.

14. The image decoding method according to claim 12, wherein, in applying the compression processing to the syntax elements, a specific parameter included in the syntax elements extracted in the syntax analysis processing is converted into a variable length code including a 3-bit type bit, a value of the type bit itself indicating an absolute value of the parameter before the compression when the value of the type bit is 0 to 5, a value obtained by adding 6 to a next value of 1 byte indicating an absolute value of the parameter before the compression when the value of the type bit is 6, and a value obtained by adding 262 to a next value of 2 bytes indicating an absolute value of the parameter before the compression when the value of the type bit is 7.

15. The image decoding method according to claim 14, wherein, in applying the compression processing to the syntax elements, when the syntax elements used in the motion prediction processing are compressed, a specific parameter included in the syntax elements is converted into a variable length code including a 3-bit type bit and a 1-bit code bit corresponding to a motion prediction result in a vertical direction, a 3-bit type bit and a 1-bit code bit corresponding to a motion prediction result in a horizontal direction, and 4-byte or less additional information added according to values of the type bits.

16. The image decoding method according to claim 14, wherein, in applying the compression processing to the syntax elements, when the syntax elements used in the differential image decoding processing are compressed, a specific parameter included in the syntax elements is converted into a variable length code including 4-bit information indicating a number of continuous 0's detected in zigzag scan, a 3-bit type bit and a 1-bit code bit corresponding to a coefficient other than 0, and 2-byte or less additional information added according to a value of the type bit.

17. The image decoding method according to claim 12, wherein, in executing the signal processing, after the processing is finished, the syntax elements used in the processing are discarded.

18. An image data converting apparatus that converts an input image bit stream into data of a format desired by a signal processing unit at a post stage, the image data converting apparatus comprising:
a syntax analyzing unit that executes syntax analysis processing on the input image bit stream; and
a syntax-element compressing unit that converts a specific parameter included in syntax elements extracted in the syntax analysis processing by the syntax analyzing unit into a variable length code including a 3-bit type bit, a value of the type bit itself indicating an absolute value of the parameter before the compression when the value of the type bit is 0 to 5, a value obtained by adding 6 to a next value of 1 byte indicating an absolute value of the parameter before the compression when the value of the type bit is 6, and a value obtained by adding 262 to a next value of 2 bytes indicating an absolute value of the parameter before the compression when the value of the type bit is 7.

19. The image data converting apparatus according to claim 18, wherein the syntax-element compressing unit converts, concerning syntax elements used in motion prediction processing in an image decoding operation, the a specific parameter included in the syntax elements into a variable length code including a 3-bit type bit and a 1-bit code bit corresponding to a motion prediction result in a vertical direction, a 3-bit type bit and a 1-bit code bit corresponding to a motion prediction result in a horizontal direction, and 4-byte or less additional information added according to values of the type bits.

20. The image data converting apparatus according to claim 18, wherein the syntax-element compressing unit converts, concerning syntax elements in differential image decoding processing in an image decoding operation, a specific parameter included in the syntax elements into a variable length code including 4-bit information indicating a number of continuous 0's detected in zigzag scan, a 3-bit type bit and a 1-bit code bit corresponding to a coefficient other than 0, and 2-byte or less additional information added according to a value of the type bit.
